(19) United States
(12) Patent Application Publication
(10) Pub. No.: US 2004/0035038 A1
(43) Pub. Date: Feb. 26, 2004

(54) Shelf edge data strip

(76) Inventor: Carl Pomerantz, Beaconsfield (CA)

Correspondence Address: CARL POMERANTZ, 567 LAKESHORE, BEACONSFIELD, H9W 4K3, CA

(21) Appl. No.: 10/602,047

(22) Filed: Jun. 24, 2003

Related U.S. Application Data
(60) Provisional application No. 60/394,297, filed on Jul. 9, 2002.

(51) Int. Cl. G09F 3/18

(52) U.S. Cl. 40/661

(57) ABSTRACT

An improved plastic price channel strip of the kind used on merchandise fixtures for example in retail outlets. These are commonly designed to receive labels providing price and other information relating to merchandise being displayed on the fixtures. By blending the corner extremities of the strip, snagging is reduced and the strip longevity and durability are significantly enhanced.

### CROSS-REFERENCE TO RELATED APPLICATIONS

This application claims the benefit of priority under Provisional Patent Application No. 60/394,297 filing date Jul. 09, 2002

### BACKGROUND OF THE INVENTION

This invention relates to label holding strips and the like commonly refereed to as data strips and label holders, of the kind commonly used on merchandise fixtures in retail outlets.

### BACKGROUND OF THE INVENTION—PRIOR ART

This invention relates to plastic label holding strips and the like commonly referred to as Data strips, of the kind used on merchandise fixtures and displays for example in retail outlets. These are commonly designed to receive labels providing price and other information relating to merchandise being displayed on the fixtures. Common retail fixtures include merchandise display shelves, wire baskets, retail peg hooks and the like.

In retail, shelf edge data strips are often attached via adhesive or mechanically attached to the front or top edge of shelving so that non adhesive pricing and bar code labels can be used along the front edge. The advantage of this system versus using adhesive labels applied directly to the edge of shelving is that non adhesive labels are less costly, and are faster and easier to replace when stock is moved, or prices or other label information changes.

A common problem inherent with existing data strips is that the height of the label and strip is greater than the thickness of the shelf edge, with the result that the bottom portion of the strip creates an overhang or lip below the front bottom edge of the shelf It also occurs that the strip overhangs the sides of the fixture, or upper edge. Even if the strip is of the same dimension or smaller than the shelf edge, a corner overhang can be created by incorrect placement of the strip, or by distortion of the strip by customers or store personnel. Because of this overhang, the corners of the strip are prone to a catching affect, whereby merchandise, customers or passersby may inadvertently come into contact with the sharp exposed corners. As well, this happens when merchandise is being moved in the vicinity of the edge and contact is inadvertently made with the strip.

There are many types of retail fixturing which feature various configurations on the shelf front edge. For example, some shelves feature flat, plain front edges, while others feature a front edge formed as an integrated C-shaped price channel which can receive snap in labels directly. In all these configurations, it is quite common to use data strips with various attachment means to the fixtures. Attachment means are often by way of adhesive applied between the price channel and the fixture. As well, the attachment means can include mechanical attachment means such that the price channel snaps in and interlocks onto the fixture, or is attached with fasteners or straps along its length.

Prior arts which summarize many of these price channel variations and their attachment means include U.S. Pat. No. 5,515,632 by Fast, U.S. Pat. No. 6,266,906 by Nagel, U.S. Pat. No. 6,263,603 by Wildrick, U.S. Pat. No. 4,745,695 by Hertzer, and U.S. Pat. No. 5,473,833 by Ostrovsky, U.S. Pat. No. 5,044,104 by Hopperdietel, U.S. Pat. No. 6,430,857 by Nagel, U.S. Pat. No. 4,606,170 by Mendenhall, U.S. Pat. No. 5,899,011 by Brinkman, U.S. Pat. No. 6,026,603 by Kump, U.S. Pat. No. 6,470,613 by Wildrick, U.S. Pat. No. 4,295,288 by Westberg, and U.S. Pat. No. 5,197,215 by Torsleff, and U.S. Pat. No. 5,263,269 by Tjarnlund.

Method of Manufacture

The common method of manufacture taught and suggested by these prior arts for these plastic price channels is by way of extrusion whereby molten plastic is forcibly extruded through a die and sizers of predetermined, shape and cross section and then cooled such that a continuous band or strip of plastic emerges and rigidly solidifies as it cools. As this process must by nature be continues, there is typically a means of cutting the strip along the production line after cooling and solidifying the strip so that parts of predetermined length are produced. The easiest, most common and cost effective manner to accomplish this segmentation is by way of a fly cutter whereby a blade guillotines the strip at predetermined intervals. Production and segmentation in this manner yields price channel segments which are typically cut perpendicular to the length of the travel of the strip, so that the final strips, when viewed from direction perpendicular to travel, is a parallelogram, with distinct corners.

While the technology readily exists to severe the segment in other than a straight line cut, or to specifically shape or round the end of the part, this is more costly and complex to achieve and is only done for other extruded products when the added expense and added process and tooling complexity are deemed warranted. Therefore in conventional strips in use commonly feature definite, often sharp corners and extremities, as the added cost and increased tooling and process complexity to avoid sharp extremities were not deemed warranted. Any one skilled in the art, upon study of the sited patents and prior arts, would conclude that a conventional straight line cut between strip segments during production, yielding a strip with defined corners, is perfectly adequate and is the accepted practice in this crowded field.

Strip Failure Mechanism

In a common version of the plastic price channel, the attachment means of the strip to a flat shelf edge is via a strip of adhesive which attaches the back wall of the strip to the front face of the shelf Over time, the strip eventually needs to be replaced due to several common failure factors. The most common cause of failure is the strip being pried away from the shelf edge. This failure mechanism typically is initiated by one of the extreme corners of the strip being pried away from the shelf edge corner by customers passing by, or pulling out product from shelving above the strip or below the strip, and catching one of the extreme corners of the strip.

This failure mechanism can further be understood by examining the adhesion forces along the adhesive zone along the length of the back wall of the strip between the strip and the shelf edge, in reaction to a point load applied to the strip in the direction away from the shelf edge. (Henceforth, the term point load should be taken to mean a concentrated force applied to the strip in a direction which pulls or pries the strip away from the shelf edge).

If this point load is applied to the strip for example midway along its length, there is a resultant stress in the adhesive zone along the back wall of the strip which is adhered to the shelf edge directly behind this mid point via adhesive tack forces.

As well, because the strip is continuous and rigid and the fact that it is attached along its entire length to the shelf edge, supporting shear forces from either side of this point will be transferred to the adjacent points along the strip length This serves to share the load and dissipate the stress from the point load along the back wall adhesive zone, so that the stresses induced in the adhesive zone from the point load applied are spread over a relatively broad area along the strip length on either side of this midway point.

The result of this is that as opposed to a limited focused point of high stress concentration in the adhesive zone directly behind the point load, there is a dissipated zone of lower stresses in the region of the point load, spread along a relatively broad length of the strip extending behind the point load and longitudinally on either side of the point load.

This is a marked contrast to when a horizontal point load is applied to the extreme end of the length of the strip, as this point is unsupported on one extremity edge/side. As a result, the resultant stress induced in the adhesive zone directly behind the point load can only be shared from the point in the adhesive zone directly behind the point load and in the sole supported direction along the strip length. Therefore a point force applied at the end of the strip induces higher stresses in the adhesive zone compared to a point load of same magnitude and direction being applied to any point inward of these extremities along the length of the strip.

Closer examination of this failure mechanism reveals that it is predominantly the loads to which the longitudinal extremities are subjected that determine the strip's useful life and durability. Further, it is the component of the forces in the direction parallel to or away from the shelf edge which serve to forcibly pull or pry the strip away from the shelf edge and cause the strip to detach and fail.

From this it can be understood that strip failure in the case of adhesive attachment means via failure in the adhesive zone typically commences at the extremities of the strip length as this is where horizontal point loads create the largest stresses in the adhesive zone. This stress concentration in the adhesive zone is further amplified once failure is initiated as explained below.

For example, when there is failure in the extreme adhesive zone such that the strip end is no longer attached in the adhesive zone directly behind a given point, if the point load is applied at the strip extremity, the length of strip which is detached from the fixture acts as a lever such that the effect of a point load on the extremity creates a concentrated stress point in the leading edge of the adhesive zone that has not yet failed. Coupling the leverage effect from the point load applied to the strip extremity, with the transfer of this leveraged force to said concentrated stress point in this leading edge zone creates a point of high stress concentration in the adhesive zone so that the failed adhesive zone length is easily propagated by even small horizontal point loads applied to the strip extremity.

Examples of point loads that are inadvertently applied to the strips are store personnel and customers passing by, placing or replacing products on store fixturing and other normal store activity. When any of the extreme ends of the strip are square, pointed, sharp or otherwise snag prone as in other prior arts, they are significantly more prone to catching and thereby creating more instances of extreme ends point loading. This creates point loading of greater intensity and frequency, thereby significantly increasing the instances of initiation and propagation of strip failure.

The mode of failure and dramatic effect of the strip extremities on the strip attachment means to fixturing is analogous whether attachment means is to the front face of the fixture, top face, bottom face. This phenomenon and failure mode including leverage effect of extremities to propagate separation and failure, is also applicable to not only adhesive attachment means, but also mechanical attachment means such as snap in C-channel, strips attached with fasteners or other mechanical means and strips strapped onto baskets or affixed to peg hooks and the like.

Prior arts sited all teach strips that are typically extruded and cut along their length with straight cuts with the result that corners are square and sharp and prone to catching and snagging, and prone to increased instances of initiation and propagation of strip failure.

As well, it is common for strips to distort over time so that the upper corners of the front window can become exposed and similarly more prone to catching by customers and store personnel and likewise initiate strip failure.

### BACKGROUND OF THE INVENTION—OBJECTS AND ADVANTAGES

The understanding of this previously unrecognized phenomenon of failure mechanism as described, yields the unexpected and surprising result that blending which can include smoothing, rounding curving or making obtuse any of the corners of the strip greatly diminishes the magnitude and frequency of occurrence of horizontal point loads applied to the extremity of the strip. This significantly and dramatically enhances the longevity of the strip by suppressing initiation and propagation of the failure mechanism described above. Even in this crowded field, with many sited prior arts, the effect of rounding of the corners during mass production of these extruded plastic price channels has never been recognized, suggested or performed. This unsuggested modification yields a surprising and unanticipatedly dramatic effect on strip longevity, with a secondary, obvious benefit of increased safety for store customers and personnel.

My strip addresses these previously unrecognized problems and solves them by modifying the strip so that it is more resistant to “catching” at the corners. This is accomplished by providing blended corners. A blended corner is here defined as comprising a radius, or curve or oblique transitional zone or obtuse angle between the intersection of the strip panel's longitudinal edge and its adjacent lateral edge extremity. As a result, because of this altered corner configuration, this new strip is much more resistant to disturbance and much less prone to detachment and failure caused by catching at the corners or prying from below or the sides or above.

This invention is also applicable to shelf edge data strips that are mechanically attached to fixturing via attachment darts or snapping into the fixture's concave edge as the failure initiation and propagation mechanism is the same. Providing blended corners to the strip likewise inhibits corner catching, thereby making the strip more resistant to wear versus prior art square-cornered shelf edge data strips.

In another variation of this invention, the upper corners of the front window can also be made angular or curved. In the case of strips which include a back flap for adhesion or mechanical attachment to shelving, the corners of this back flap can as well be made blended to reduce the catching affect.

It is also common to use short lengths of strips on baskets and other shorter lengths of store fixturing, such as at the end of peg-hooks. The same corner catch affects apply, and this invention also includes these shorter length holders.

In different embodiments of this invention, the corners that can be made rounded, curved obtuse or otherwise blended can include the bottom corners, the top corners, the corners of the front window, and/or the corners of the back flap, or any other exposed corners of the strip or holder. As well, corners on other similar extruded parts such as decorative shelf edging or other signage means are also included.

### SUMMARY

In accordance with the present invention, a plastic price channel strip comprises a length having one or more blended or oblique corners thereby significantly enhancing the strip's longevity and durability.

### DRAWINGS_FIGURES

FIG. 1 is a schematic diagram of a plastic extrusion line.

FIG. 2 is perspective view of a prior art data strip with adhesive attachment means.

FIG. 3 is a plan view of prior art strip.

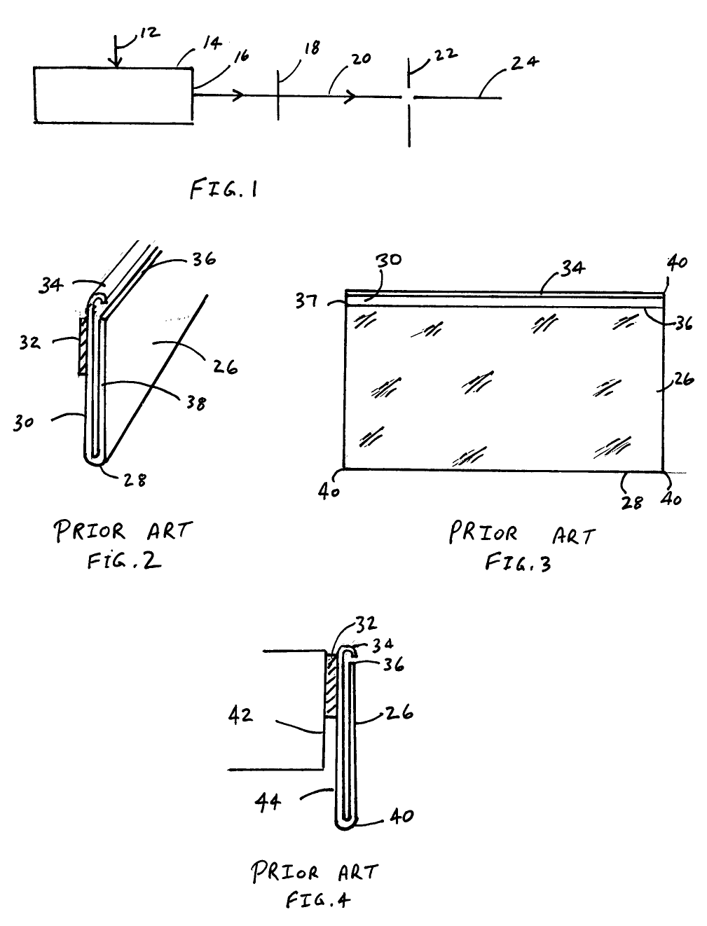

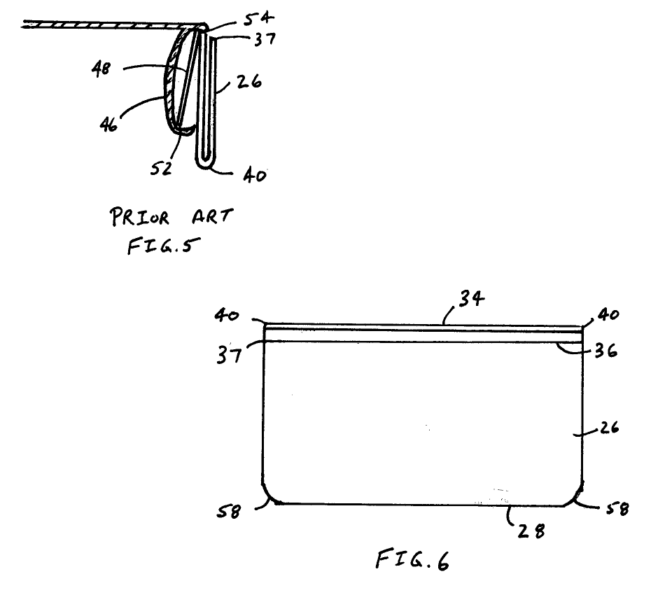

FIG. 4 is side view of prior art with adhesive attachment means applied to shelf edge

FIG. 5 shows one embodiment of prior art strip with mechanical attachment means.

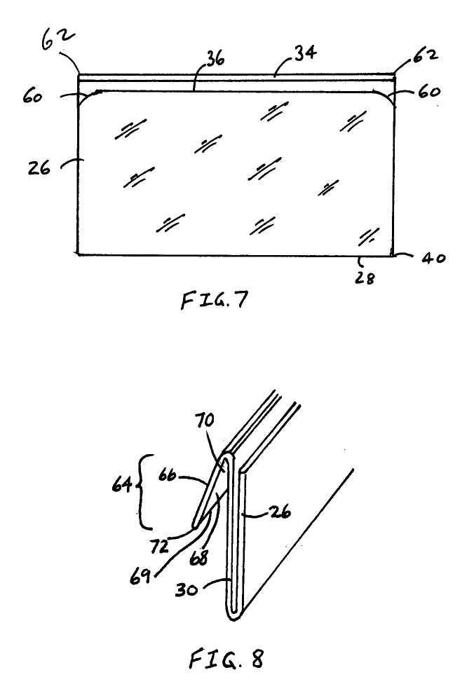

FIG. 6 is front view of one embodiment of the invention featuring blended bottom corners

FIG. 7 is a front view of another embodiment of the invention showing additional smoothed extremities

FIG. 8 is a side view of a strip with a back flap attachment means.

FIG. 9 is a front view of another embodiment of the invention with blended bottom corners.

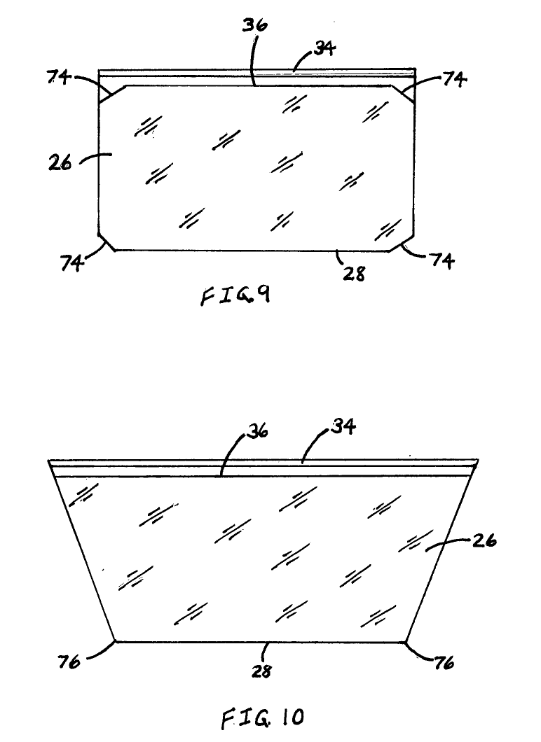

FIG. 10 is a front view of another embodiment of the invention with oblique sides.

### DETAILED DESCRIPTION

Referring to the schematic of a plastic extrusion line in FIG. 1, plastic 12 is fed into an extrusion machine 14 which melts the plastic and forces it through an extrusion die 16 and sizers 18 beyond which the continuous plastic strip 20 is conveyed and cooled before it is cut by a cutter 22 and completed segments 24 of predetermined length are produced. This is a continuos method of fabrication and for speed, economy and minimal complexity, the cutter 22 is typically a straight blade that guillotines the strips at predetermined lengths as the strip goes by.

Referring to FIG. 2, this perspective view of a typical prior art strip is comprised of a front panel 26 whose base joins to a bottom edge region 28 which connect to the strip back panel 30. A strip of adhesive 32 runs along the back length of the strip and it is via this attachment means that the strip can be affixed to a shelf edge. The top of the back panel 30 often is capped with a flanged end ridge 34 so that pricing tickets do not easily dislodge from inside the windows. The front panel 26 is typically clear so that pricing or ticket labels can be inserted inside the window and can be viewed through the window from the front. The front panel features an upper edge region 36 and side edge region 38. The length of this strip can vary from about 1.5 inches in the case of small segments, up to or beyond 48 inches, with 48 inches being the common length of a retail shelf edge.

Referring to FIG. 3, this front view of typical prior art strip shows that all corners are typically squared or sharp. This would include the corners of the back wall 30, as well as the corners of the front window 26. When the strip is new and attached to the store fixture with this embodiment, the extreme corners of the back wall 30 and the front window 26 are typically parallel and in close proximity and therefore equally prone to catching and initiating failure by passersby. However, through repeated reopening of the front window 26 often over time the window may tend to remain pried open so that while the back wall may remain flush with the store fixture to which it is attached, the front widow top corner 37 may protrude and thus become more prone to catching and initiating and propagating strip failure.

FIG. 4 shows a side view of a strip attached to shelf 42 via adhesive strip 32. In this embodiment, the depth of the shelf face 42 is less than the depth of the strip so that the section of strip 44 hangs down lower than the bottom of the shelf. In this embodiment, the lower strip corners 40 are particularly exposed to store traffic and are particularly vulnerable to catching and snagging at the corners and thereby failing.

FIG. 5 illustrates another prior art embodiment whereby shelf edge 46 is concave shaped so as to mechanically interlock with attachment means panel 48. Attachment means panel 48 features distal edge corners 52 as well as back panel upper corners 54 and bottom edge region corner 40 and upper front panel corner 37

FIG. 6 illustrates a front view of one embodiment of the invention whereby the bottom corners 58 have been blended to greatly reduce the catching and snagging tendency of these corners on passersby. By so doing, the life span of the strip is greatly enhanced.

Referring to FIG. 7, in another embodiment of the invention, the upper front panel corners 60 have been blended. In addition, the upper back wall corners 62 could be similarly blended to further increase strip longevity.

Referring to FIG. 8, this side view of a strip includes a front panel 26 and back panel 30 plus an attachement means panel 64 with an upper face 66 and a bottom face 68. In this embodiment, the attachment means of the strip to the store shelf is via the attachment means panel 64. This panel includes a longitudinal distal edge region 69. In one embodiment, angle 70 is close to zero so that adhesive is applied to face 66 for attachment to the front edge of shelving. Alternatively, angle 70 could be approximately 110 degrees with adhesive applied to face 68 so that face 68 could be adhered to the top front edge of shelving. Alternatively, back flap 64 could follow various configurations so that it mechanically attaches to fixturing. In any of these cases, blending of any of the corners including 72 would similarly serve to reduce the likelihood of catching this corner and thereby this would increase the life expectancy of the strip.

FIG. 9 is another embodiment of the invention, wherein blended corners 74 are provided in the form of obtuse arcs at the corners.

FIG. 10 is another embodiment of the invention, wherein lower bottom corners 76 are blended by virtue of being obtuse so as to provide a benefit analagous to rounding the corners.

### CONCLUSION, RAMIFICATION, SCOPE

Thus the reader will see that, by careful examination of the failure mechanism of common prior art plastic shelf strips affixed to fixturing, the combination of blending the corners of the shelf channel strip with this failure mechanism results in a surprising, unanticipated improvement of strip longevity. This new and unexpected result reduces the problem of corner catching and snagging which in other prior arts leads to comparatively faster strip failure, This has never been recognized or addressed, even in this crowded field of many patents. Furthermore, this previously unappreciated advantage of blending of corners is not only not suggested in prior arts, it is contrary to the implied teaching of prior arts which make reference to and imply common extrusion production methods which typically would include a straight guillotine cut at the extreme edges of the strip. Blending of the corners involves awkward and involved steps and complex tooling whose benefits have not been previously questioned or evaluated, and therefore prior arts feature abrupt, perpendicular, snag-prone unblended corners. Additional benefits of my invention include improved safety as snagging can cause injury to passersby, as well as less risk of damaging products that are being moved by passersby and might otherwise risk being snagged on sharp corners.

While my above description contains many specificities, these should not be construed as limitations on the scope of the invention, but rather as an exemplification of several preferred embodiments thereof Many other variations are possible. For example, if any of the corners of the strip are blended, that is to say not sharp, then the benefits of improved strip durability and longevity will be achieved. Blending of the corners might include blending edges in a plane other than the plane of a given panel.

Accordingly, the scope of the invention should be determined not by the embodiments illustrated, but by the appended claims and their legal equivalents.

I claim:

1. A label holding strip for displaying information labels in association with merchandise displays, comprising
(a) a continuously extruded section of plastic material including front and back panels joined integrally along a bottom edge region of said strip and forming an upwardly opening pocket for the removable reception of labels, and
(b) at least one side edge region at an extreme longitudinal end of said front panel
with interconnection of said side edge region and said bottom edge region being substantially blended and smooth whereby a substantially snag-free transitional edge is provided between said bottom edge region and said side edge region.

2) The strip of claim 1 wherein the transitional edge is comprised of one or more obtuse arcs.

3) The strip of claim 1 wherein the transitional edge is comprised of a curved edge.

4) The strip of claim 1 wherein the transitional edge is comprised of an obtuse intersection between said side edge region and said bottom edge region.

5. A label holding strip for displaying information labels in association with merchandise displays, comprising
(a) a continuously extruded section of plastic material including front and back panels joined integrally along a bottom edge region of said strip and forming an upwardly opening pocket for the removable reception of labels,
(b) an upper front panel edge region parallel to the bottom edge region
(c) at least one side edge region at one extreme longitudinal end of said front panel
with interconnection of said side edge region and said upper edge region being substantially blended and smooth whereby a substantially snag-free transitional edge is provided between said upper edge region and said side edge region.

6) The strip of claim 5 wherein the transitional edge is comprised of one or more obtuse arcs.

8) The strip of claim 5 wherein the transitional edge is comprised of a curved edge.

9) The strip of claim 5 wherein the transitional edge is comprised of an obtuse intersection between said side edge region and said bottom edge region.

10. A label holding strip for displaying information labels in association with merchandise displays, comprising
(a) a continuously extruded section of plastic material including front and back panels joined integrally along a bottom edge region of said strip and forming an upwardly opening pocket for the removable reception of labels, and
(b) an attachment means panel joined integrally along said back panel
(c) a longitudinal distal edge region on the attachment panel and
(d) at least one side edge region at one extreme longitudinal end of said attachment panel
with interconnection of said side edge region and said longitudinal distal edge region being substantially blended and smooth whereby a substantially snag-free transitional edge is provided between said side edge region and said longitudinal distal edge region.

11) The strip of claim 10 wherein the transitional edge is comprised of one or more obtuse arcs.

12) The strip of claim 10 wherein the transitional edge is comprised of a curved edge.

13) The strip of claim 10 wherein the transitional edge is comprised of an obtuse intersection between said side edge region and said bottom edge region.
